(19) United States
(12) Patent Application Publication
(10) Pub. No.: US 2017/0246814 A1
(43) Pub. Date: Aug. 31, 2017

(54) Thermoplastic fiber, hybrid yarn, fiber perform and method for producing fiber performs for fiber composite components, in particular high performance fiber composite component, using the same, fiber composite component and method for producing fiber composite components, in particular high performance fiber composite components

(71) Applicant: Faserinstitut Bremen e.V., Bremen (DE)

(72) Inventors: Patrick Schiebel, Bremen (DE); Lars Bostan, Bremen (DE)

(73) Assignee: Faserinstitut Bremen e.V., Bremen (DE)

(21) Appl. No.: 15/481,435

(22) Filed: Apr. 6, 2017

Related U.S. Application Data
(63) Continuation-in-part of application No. 13/838,656, filed on Mar. 15, 2013, now abandoned.

(30) Foreign Application Priority Data
Nov. 14, 2011 (DE) PCT/DE2011/001984

(51) Int. Cl. B29C 70/34; D01D 5/08; D01F 6/66; B29C 70/24; B29C 35/08

(52) U.S. Cl. CPC B29C 70/34; B29C 70/24; B29C 35/0805; D01F 6/665; D01D 5/08; B29C 2035/0811; B29K 2105/253

(57) ABSTRACT

A method for producing a fiber preform or semi-finished textile product comprises providing a fiber preform or semi-finished textile product comprising at least one thermoplastic fiber. The thermoplastic fiber has a core constructed of a first material, a shell constructed of a second material positioned to surround the core, and magnetic particles that are one of mainly arranged in the shell, almost exclusively arranged in the shell, and exclusively arranged in the shell. Continually adding the fiber preform or semi-finished textile product with simultaneous heating thereof in continuous passing through or passing by a magnetic induction heating device or the same by way of a relative movement. Fixing the fiber preform or semi-finished textile product by allowing the fiber preform or semi-finished textile product to rigidify.

### PRIORITY

This application is a Continuation in Part of U.S. patent application Ser. No. 13/838,656 which is in turn a Continuation in Part of International Application PCT/DE2011/001984 filed Nov. 14, 2011, which takes priority from German Patent Application DE 10 2010 052 078.0 filed Nov. 18, 2010, the contents of both prior applications being incorporated herein by reference. This application also takes priority from U.S. Provisional Patent Application 61/613,541 filed Mar. 21, 2012, the contents of which are also incorporated herein by reference.

### BACKGROUND

The present invention relates to a thermoplastic fiber, a hybrid yarn, in particular suitable for thermal fixing of fiber preforms for, preferably endless fiber reinforced, fiber composite components, in particular high performance fiber composite components, a fiber preform and a method for producing fiber preforms for, preferably endless fiber reinforced, fiber composite components, in particular high performance fiber composite components, a fiber composite component and a method for producing, preferably endless fiber reinforced, fiber composite components, in particular high performance fiber composite components. The fiber preform is a product or semi-finished product which is constructed from fibers. The carrying layer can consist for example of a tool, a film, a fiber structure or a laminate. High performance fiber composite components are fiber composite components with particularly good thermal and mechanical properties.

Throughout the fields of traffic engineering, aeronautical, and aerospace engineering, in the fields of mechanical engineering, and in the field of sports, there are increasingly requirements for lightweight construction solutions. Where masses are moved, lightweight construction is an efficient method in order to increase the performance capacity of the product and to simultaneously reduce the required energy in operation and thus the running costs. Carbon fiber reinforced plastics have a high lightweight construction potential as they have a high specific strength and rigidity with a low density. The use of structures made of carbon fiber reinforced plastics on a large scale frequently fails, however, due to its production and material costs. In order to be able to produce components from this material at competitive costs the production process must be extensively automated and have a low cycle time. Furthermore, the material costs must be minimized and all mechanical, thermal and chemical requirements thereby fulfilled.

Thermoplastic matrices have advantages over duroplastics. They can be maintained at room temperature without limitation, no dissolvents must be used during processing, the cycle times are shorter, the materials are weldable and more tolerant to loads than duromers due to a higher viscosity. Endless carbon fibers in thermoplastic matrices are processed today in fabric form to so-called organo sheets. The production process comprises a plurality of work steps. Firstly (0°/90°) fabrics must be produced. The sizing agent necessary for the web process to protect the fibers is removed before impregnation with the melted thermoplastics through a wet chemical process. Subsequently the dried fabrics are impregnated with the thermoplastic melt or via the film stacking method. The matrix has a very high viscosity of 10̂3 to 10̂5 Pa·s (water 1 mPa·s at 20° C.). In order to ensure a good impregnation of all fibers, after soaking the individual fabrics are constructed to form laminates and consolidated by means of a double belt or interval hot press. The laminates of the organo sheets can be constructed up to a thickness of 10 mm and be processed in a reshaping process to form components.

Disadvantages in this process are the high-resource manufacturing process and the expensive starting materials. For this reason, the field of application has to date been predominantly limited to individual component groups in aviation.

In comparison with organo sheets, a shorter production chain can be achieved by using hybrid yarns and textiles. In order to ensure short flow paths and an associated rapid impregnation of the reinforcement fibers with the thermoplastic matrix the matrix must be brought as close as possible to the filaments. Hybrid textile structures which are equipped, besides the endless reinforcement fibers for example of carbon, with a thermoplastic component for consolidation can be easily processed to form fiber composite components. In case of commingling hybrid yarns both components are mixed well in the yarn cross-section so that the flow paths for filament wetting are minimized during the consolidation phase. Disadvantages are, however, slight filament damage and orientation deviations within the yarn. The carbon filaments are swirled together with the thermoplastic filaments for example through air jets and do not subsequently lie—as in a roving—parallel to each other and thus result in a reduction in the possible component rigidities and strengths.

For the load-optimized design and maximum substance exploitation it is a precondition that the particular advantages in terms of properties of the fiber composite materials fully take effect.

The tailored fiber placement (TFP) method offers great potential for an efficient production of load-optimized designed components from fiber composite materials. In TFP technology reinforcement fibers are continuously laid up in textile preforms corresponding to the stress directions. A virtually ideal textile reinforcement structure is thus facilitated. A stitching machine positions and fixes the fibers corresponding to the force flow and stress analyses on a stitching base (carrying layer). Through coordinated lay-up of a plurality of stitched-on preforms a semi-finished product for a multi-axis loadable component can be subsequently produced. The process is highly automated and facilitates a high productivity as a plurality of stitching heads are arranged beside one another which can simultaneously work on a common stitching base.

Disadvantages are filament damage through the stitching process, fiber undulations and resin nests which arise through the penetration of stitching threads. In addition, there are limitations in the maximum number of layers of a TFP preform. The further processing to a component frequently takes place in staff-intensive and time-intensive resin injection or resin infusion methods so that current applications are limited to components with low numbers of parts.

Conventional tow placement systems, as offered for example by Cincinnati and Coriolis Composites, use in particular pre-impregnated fibers or fiber bands. These can be based upon thermoplastic or duromer matrix systems. Repetition precision in the manner of +/−0.3 mm can be achieved. For sufficient adhesion of the fibers pressure forces of 100 N to 1500 N are necessary depending upon the matrix. A robot-guided lay-up head creates, with a ¼″ wide yarn, a lay-up output of approximately 18 kg/h. Higher lay-up rates can be achieved through a parallelization.

Investigations into curved lay-up paths have shown, however, that in case of in-plane radii of approximately 1.5 m already clear fiber waviness arises. Load-optimized fiber orientations for complex stress patterns, as used in TFP methods, cannot be realized with this technology. The reason for this is the high rigidity of the fiber band which does not facilitate a displacement of the filaments relative to each other, in comparison with commingled hybrid yarns.

In general shell/core bi-component fibers are used today in the clothing and furniture industry, filter technology and medical technology. The shell/core ratio can hereby lie between 1/99 and 50/50 depending upon the application. The use of bi-component fibers as binding fibers has already been tried and tested in non-woven fabric production. Shell components are used here which have a lower melting point than the core components and can thus be directly thermally activated. This cannot be realized for thermally stressed components, as the fiber shell also contributes to the later matrix of the fiber composite component.

It thus remains to be stated that, in spite of the high technical potential of the fiber-reinforced thermoplastics, it has not been possible to use these to date for many applications due to the expensive and high-resource production process. When using organo sheets there is frequently 30% production waste and more. The textile fiber structures often lead to reduced rigidities and strengths in the component as production-related fiber damage and undulations arise in the web or stitching process. Existing tow placement methods are based upon expensive semi-finished products, with which only large in-plane radii can be realized. The lightweight construction potential for components with complex stress patterns is therefore only insufficiently exploited.

German Document DE 10 2007 009 124 A1 discloses an induction-supported production method and a production device for molded elements of fiber composite materials. The method comprises the lay-up of a band-form material in a molding element. Said band-form material contains both reinforcement fibers and also thermoplastic or duroplastic resin. The resin is provided with magnetic particles which lead, upon lay-up, to heating of the band-form material through magnetic induction heating. The magnetic particles are distributed homogeneously in the resin, so that upon lay-up the whole resin is melted and the band-form material is already brought into the three-dimensional end form. A high proportion of the magnetic additive, relatively large lay-up radii and a limited degree of automation in mass production are associated with this.

### SUMMARY

It is thus an object of the invention to facilitate an extensively automated, material-saving and thus economical production of fiber composite components. This object is achieved with a thermoplastic fiber. The heating rate will be particularly advantageous if there is a high proportion or total share of the particles in the shell and only a small proportion or zero share in the core. This object is further achieved with a hybrid yarn, in particular suited for thermal fixing of fiber preforms for, preferably endless fiber reinforced, fiber composite components, in particular high performance fiber composite components, comprising a plurality of preferably round reinforcement fibers and a plurality of preferably round thermoplastic fibers, wherein at least some of the plurality of thermoplastic fibers include at least proportionately ferromagnetic and/or ferrimagnetic particles, preferably in the nanometer range. The nanometer range relates to the individual or primary particles.

The present invention also provides a fiber preform and a method for producing fiber preforms. The fiber preform or the semi-finished textile product is at least partially built up by the hybrid yarn and/or the thermoplastic fiber. Further, the invention provides a nonwoven fabric, non-crimp fabric, multiaxial multiply fabric, winding form, woven fabric, knitted fabric or braided fabric. In addition, the invention provides a fiber composite compound according to claim 32 and a method for producing the same.

According to one contemplated embodiment of the invention, the thermoplastic fiber includes a first material and a second material that are identical. It is further contemplated that in some embodiments the first material and the second material can be different. This can be particularly advantageous for filters etc.

In some contemplated embodiments, the diameter of the individual particles is in a range of about 10 nm to about 20 nm and in some embodiments preferably about 13 nm. In one anticipated embodiment, the diameter of agglomerates of the particles is in a range of about 100 nm to about 200 nm and preferably about 150 nm.

Conveniently, the thermoplastic fiber comprises or consists of polyetherketone, in particular polyetheretherketone (PEEK), polyphenylene sulphide (PPS), polymide, in particular polyetherimide (PEI), or polysulfone (PSU), in particular polyethersulfone (PES). Said thermoplast can be considered as high performance thermoplast. The polymer Vestakeep 2000 G seems to be particularly suitable.

In some embodiments the thermoplastic fiber are unstretched. Some embodiments further contemplate the particles are iron oxide modified.

In some embodiments, the diameter of the core may be in a range of about 5 μm to about 60 μm and/or the thickness of the shell may be in a range of about 0.1 μm to about 20 μm. In further contemplated embodiments, the concentration of the particles in the shell is in a range of about 10 weight percent to about 50 weight percent. It is further contemplated that the viscosity of the thermoplastic fiber can be in a range of about 100 to 1000 Pa·s.

Some contemplated embodiments included providing with the hybrid yarn that the thermoplastic fibers respectively include a core, which includes or consists of a first material, and a shell surrounding the core, which includes or consists of a second material. The core-shell-structure is particularly advantageous.

The invention also contemplates that the first material and the second material can be identical. Alternatively, the first and the second material can be different. And it is further contemplated that the particles can be advantageously arranged mainly, almost exclusively or exclusively in the shell.

According to one anticipated embodiment, the diameter of the individual particles can be in a range of about 10 nm to about 20 nm and preferably about 13 nm. Additionally, the diameter of agglomerates of the particles may be in a range of about 100 nm to about 200 nm and preferably is about 150 nm.

In some contemplated embodiments, the reinforcement fibers can usefully comprise or consist of inorganic fibers, in particular carbon or glass, or synthetic polymers, in particular aramid. The thermoplastic fibers can advantageously comprise polyetherketone, in particular polyetheretherketone (PEEK), polyphenylene sulphide (PPS), polyimide, in particular polyetherimide (PEI) or polysulfone (PSU), in particular polyethersulfone (PES) or consist thereof. In such embodiments, the thermoplastic fibers can be advantageously unstretched. Additionally, the particles can be usefully iron oxide modified such that the particles are modified iron oxide particles. The modification comprises particles having a core/shell structure, the core comprising at least one iron oxide selected from Fe2O3 and Fe3O4. The shell comprises or consists of amorphous silica and usually displays a thickness of the shell is 5-20 nm. The shell improves the compatibility of the particles with the thermoplastic material, to make it easier for it to be able to disperse uniformly in the thermoplastic material.

In a particular embodiment of the invention, the BET surface area of the particles is 10-70 m2/g. The best results when used for conductive heating are obtained with particles having a BET surface area of 15-25 m2/g. The particles may be in form of isolated primary particles or aggregates. The primary particles are substantially pore-free, but have free hydroxyl groups on the surface and may have different degrees of aggregation. The aggregates are three-dimensional aggregates. In general, the aggregate diameter, in one three-dimensional direction in each case, is preferably not more than 250 nm, generally from 30-200 nm. Several aggregates may combine to form agglomerates. These agglomerates can be separated again easily. In contrast, the division of the aggregates into the primary particles is generally impossible.

The content of iron oxide is 50-90% by weight, preferably 75-85% by weight, calculated as Fe2O3 based on the core/shell particle.

The core of the particles preferably comprises the iron oxides haematite, magnetite and maghemite. The proportion of haematite determined from the X-ray diffractograms preferably is 20-30 by weight, that of magnetite 30-60% by weight, and that of maghemite 40-50% by weight, where the proportions add up to 100% by weight.

According to one contemplated embodiment of the invention, the reinforcement fibers and the thermoplastic fibers are homogeneously mixed. The diameter of the reinforcement fibers can also be in a range of about 5 μm to about 15 μm. For example, the range of diameters of reinforcement fibers is about 5 μm to about 11 μm for carbon, about 5 μm to about 13 μm for glass and about 10 μm to about 15 μm for aramid and basalt.

In some contemplated embodiments, the fiber volume content of the reinforcement fibers within the hybrid yarn is in a range of about 50 volume percent to about 70 volume percent. For example, in the aviation sector fiber volume contents of 50 volume percent, regarding composites with thermoplastic matrix, are often required.

In some embodiments, the fiber preform or semi-finished textile product can be produced by using the TFP and/or Tow Placement Technology.

The invention also contemplates that in the method for producing fiber preforms, the hybrid yarn can be pressed during or after lay-up onto the carrying layer.

In a preferred embodiment of the fiber composite component, the concentration of the particles is in a range of about 0.01 volume percent to about 20 volume percent, and more preferred of about 0.01 volume percent to about 2 volume percent.

The invention is based upon the surprising recognition that through the special design of the thermoplastic fiber and of the hybrid yarns, a thermal bonding of core-shell fibers, where the core and the shell consist of the same material can be done without decreasing the strength of the fiber core and a resource-efficient process chain can be realized for the production of the thermoplastic fiber and of high performance fiber composite components even for complex geometries.

### BRIEF DESCRIPTION OF THE DRAWINGS

Further features and advantages of the invention follow from the attached claims and the following description, in which a plurality of exemplary embodiments are individually explained by reference to the schematic drawings, in which:

FIGS. 1 to 3 show cross-sectional views of individual thermoplastic fibers of a hybrid yarn according to particular embodiments of the invention;

FIGS. 4 to 6 show cross-sectional views of a plurality of thermoplastic fibers comprising one or more of the thermoplastic fiber types of hybrid yarn, shown in FIGS. 1 to 3, according to particular embodiments of the invention;

FIGS. 7 and 8 show cross-sectional views of hybrid yarns according to particular embodiments of the invention;

FIGS. 9 and 10 show a side view and a top view to illustrate a method for producing fiber preforms according to particular embodiments of the invention;

FIG. 11 shows an example of a process chain for CFRTP (Carbon Fiber Reinforced Thermoplastic)-Parts made by hybrid performs;

FIG. 12 shows hybrid TFP-preforms for a hatrack bracket with the side-by-side principle (left) and FEA of CFRP-Part with Tsai-Wu failure criteria (right);

FIG. 13 shows hybrid TFP-preforms for thermoplastic window frame made from commingled yarns (left) with detail (right);

FIG. 14 shows polished cut image of unidirectional laminates made of Nm 3.2 TPFL CARBON/PPS, Schappe Techniques commingling yarn (left) and TICONA® PPS-Fortron 032000 SF3001/Tenax®—E HTS40×011 12K 800 tex side-by-side (right);

FIG. 15 shows a comparison of tensile properties of laminates made from hybrid preform and commercial CFRTP-Laminates made from woven fabrics;

FIG. 16 shows the influence of MagSilica® VP300 on Vestakeep 2000 G viscosity;

FIG. 17 shows core/shell filaments; and

FIG. 18 shows the heat up behavior of different test specimen.

### DETAILED DESCRIPTION

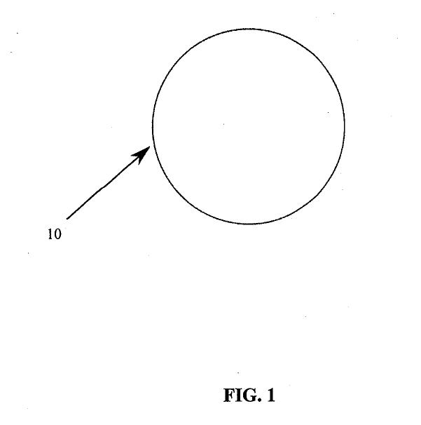

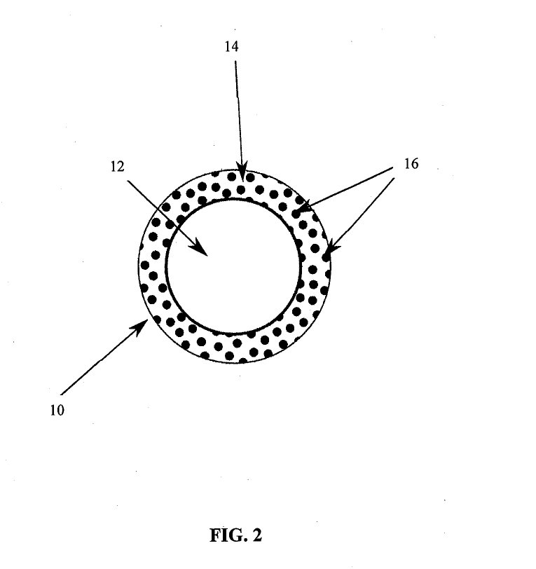

FIG. 1 shows a thermoplastic fiber 10 which does not contain any ferromagnetic and/or ferrimagnetic particles, while the thermoplastic fiber shown in FIG. 2 comprises a core 12 and a shell 14 surrounding the core, wherein the core 12 and the shell 14 ideally consist of the same material, apart from the fact that the shell 14 is additionally provided, preferably evenly, with ferromagnetic particles, of which only a few are identified by the reference numeral 16.

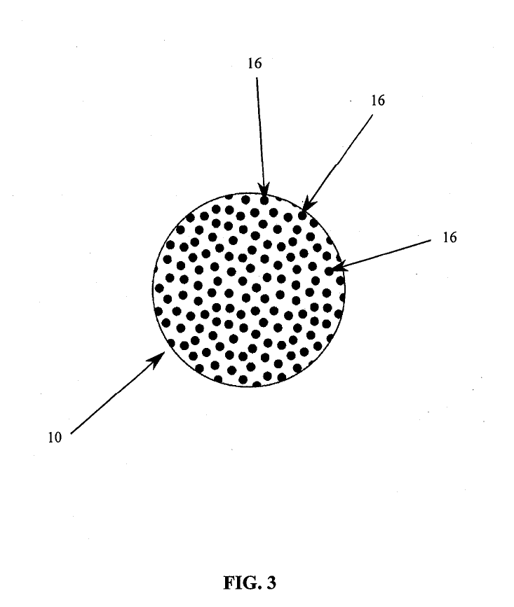

The thermoplastic fiber 10 shown in FIG. 3 is evenly provided with ferromagnetic particles, of which only a few are identified by the reference numeral 16. Although the ferromagnetic particles are shown spherically in FIGS. 2 and 3 it will be appreciated that they can also have other forms.

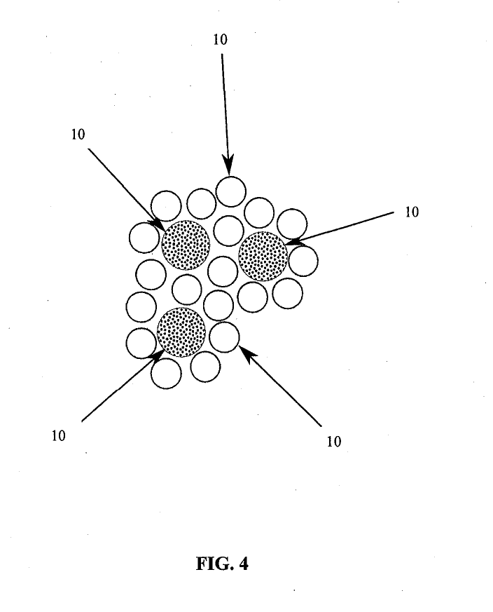

FIG. 4 shows a multitude of thermoplastic fibers 10 as a mixture of the thermoplastic fiber types shown in FIGS. 1 and 3, whereby merely some of the thermoplastic fibers are identified. The size ratios serve only for better illustration. Uniform diameters are ideal for homogeneous mixing.

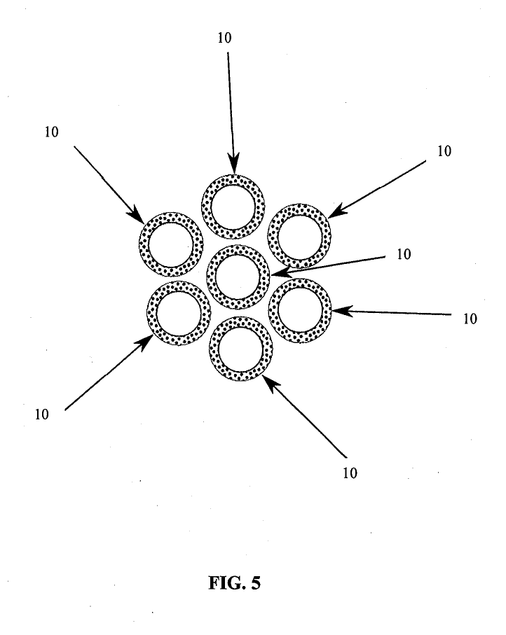

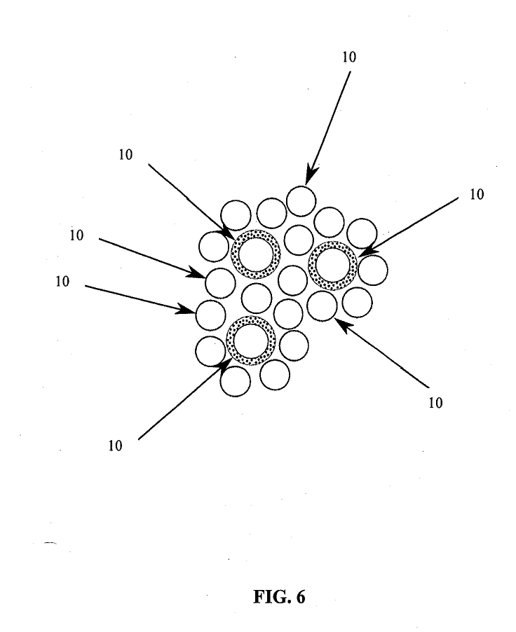

FIG. 5 shows a plurality of thermoplastic fibers 10 of the type shown in FIG. 2. The final result is the mixture shown in FIG. 6 of the thermoplastic fiber types shown in FIGS. 1 and 2, whereby only a few thermoplastic fibers are identified by the reference numeral 10. The mixture shown in FIG. 6 comprises a minimum particle proportion (minimum or better reduced nanoparticle concentration: in the hybrid yarn, non-modified and shell-modified thermoplastic fibers are present) (maximum or better high nanoparticle concentrations: all thermoplastic fibers are evenly modified over the thermoplastic fiber cross-section).

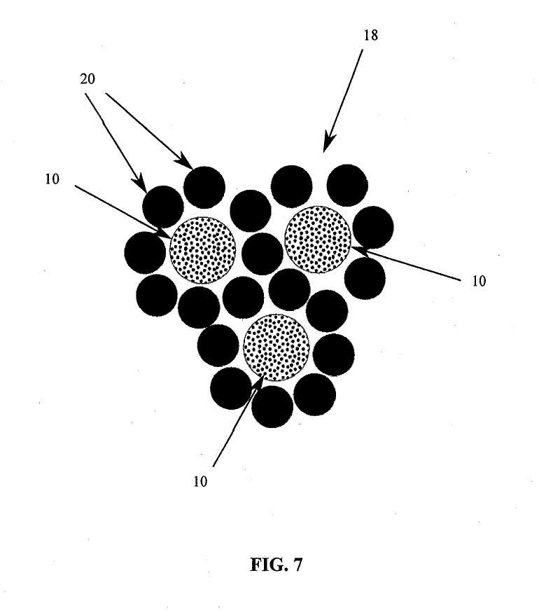

FIG. 7 shows a hybrid yarn 18 made of thermoplastic fibers 10 of the type shown in FIG. 3 and also reinforcement fibers 20, of which only a few are identified.

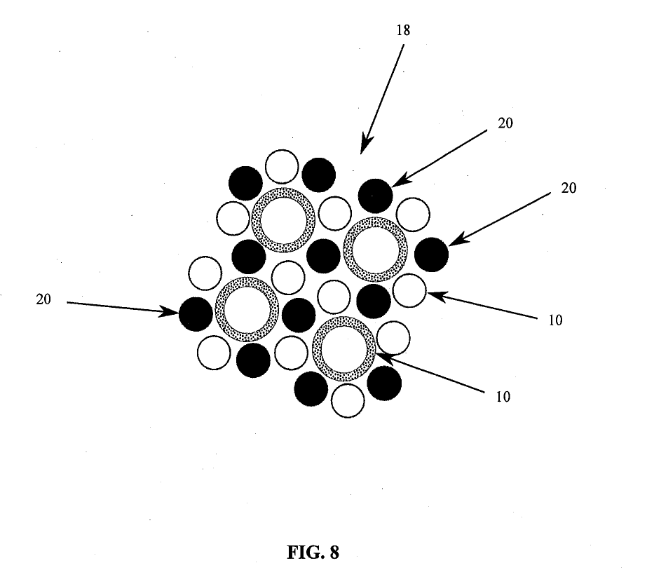

The hybrid yarn shown in FIG. 8 consists in principle of the plurality of thermoplastic fibers shown in FIG. 6, of which only a few are identified by the reference numeral 10, and of reinforcement fibers 20, of which likewise only a few are identified.

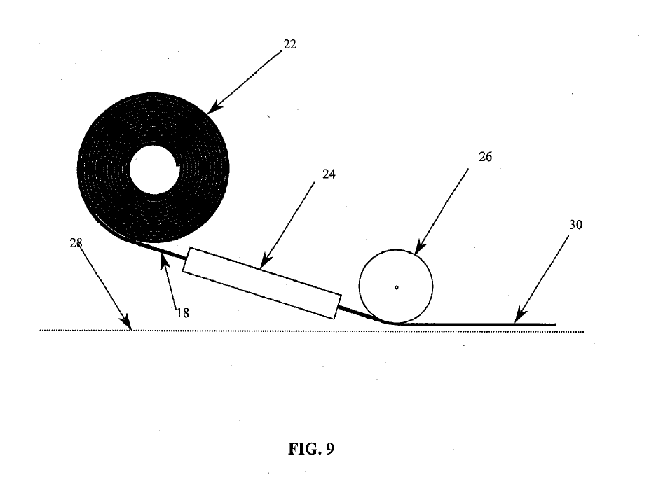

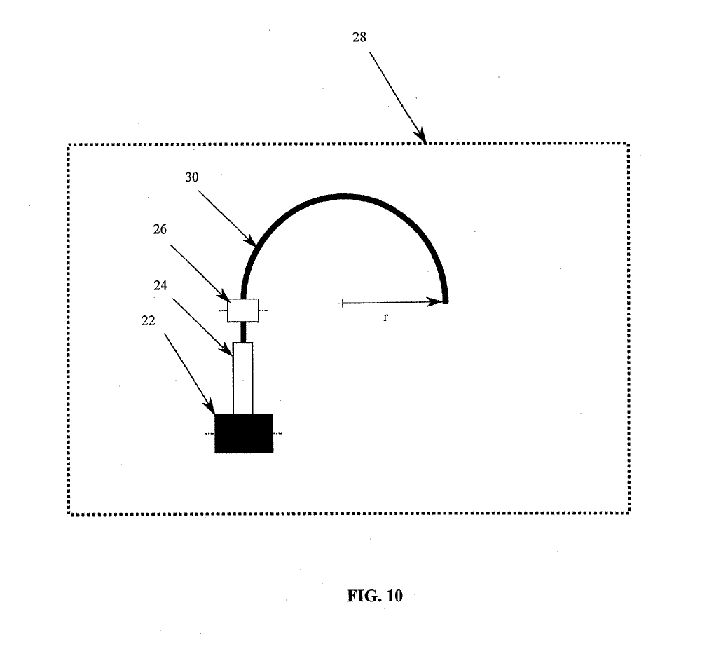

FIGS. 9 and 10 show how a hybrid yarn 18 according to a particular embodiment of the invention, which is wound on a coil 22, is unwound from it and passed through a magnetic induction heating device in the form of an induction coil 24 and subsequently laid up by means of a pressure roller 26, which is optionally cooled, on a carrying layer 28 and pressed thereon. In an alternative, for example the hybrid yarn 18 or a plurality of thermoplastic fibers 10 of the type shown in FIG. 2, a so called fiber preform can be fixed under tension and the induction heating device moves along the length of the yarn. The laid up hybrid yarn sticking to the carrying layer is supposed to be identified by the reference numeral 30. FIG. 10 shows the path curve with a lay-up ratio r in the magnitude of approximately 20 mm as far as infinite.

In one contemplated embodiment of the invention, the hybrid yarns 18 are produced from functionalized, that is to say shell-selectively inductively meltable shell 14—core 12 thermoplastics 10, preferably polyetheretherketone (PEEK) and reinforcement fibers 20, preferably carbon fibers. In order to produce a fiber preform by means of the previously described modified TFP method, the shell 14 of the thermoplastic fibers 10, modified with ferromagnetic particles 16, preferably iron oxides such as MagSilica®, is inductively activated and melts. During the pre-fixing the melted shell component hereby acts as a binding agent. In contrast with the normal TFP method with a stitching head, the use of stitching threads can hereby be omitted, which otherwise leads to filament damage, fiber undulations and resin nests. Furthermore, with this method there is no limitation of the number of layers as the layers are stuck one on top of the other and do not need to be stitched.

The high flexibility of the hybrid yarn further facilitates very small lay-up radii and is thus superior to the tow placement method with complex component geometries.

On the basis of the preliminary investigations for the shell-core distribution within the bi-component thermoplastic fibers, a shell volume portion of 10% by volume could be technically realized. In terms of large scale, lower shell portions in the region of 1% can be achieved so that the required portion of ferromagnetic particles in the component can lie below 1%.

A first example of a process chain for manufacturing endless fiber reinforced fiber composite components out of hybrid yarn will now be described. It can be divided into the following sub-steps:

### Hybrid Yarn Production

In a bi-component melting-spinning process the same thermoplastic is used for the shell and also for the core of the thermoplastic fiber. The shell is hereby modified with ferromagnetic particles. By means of for example the commingling method, modified air texturing machines or friction spinning, the shell-core thermoplastic fibers and the reinforcement fibers can be homogeneously mixed to a hybrid yarn in a ratio which corresponds to the later fiber volume content of the fiber composite component. The fiber finenesses are orientated to the hybrid yarn homogeneity and the resulting fiber composite component homogeneity.

### Preforming Tow Placement

A lay-up head (not shown) provided with magnetic induction heating technology thermally activates the shell of the thermoplastic fibers via the ferromagnetic particles so that the hybrid yarn can be laid up and fixed in accordance with force flow on a 2D development of a component end contour (carrying layer). Undulations of the reinforcement fibers and limitations in the number of layers can be avoided in this method in comparison with normal TFP technology.

The lay-up head can be installed both on a robotic arm and on a portal system. It is also possible with the described lay-up technology to lay up different hybrid yarns on any two-dimensional paths. The fiber architecture can thus be optimally adapted to the later fiber composite component load in order to thus fully exploit the material potential. Through lay-up on the end contour all the material used is used in the fiber composite component. Through this efficient use of material, in spite of expensive starting materials, high performance fiber composite components can be produced at favorable prices. This technology of a lay-up head can also be transferred to other methods, such as form example the winding method.

### Consolidation

The three-dimensional forming and consolidation can subsequently take place in a thermoforming process.

The installation technology can be adapted well. This offers freedom in the component geometry which can be produced. In addition, the method is suitable—due to the low refitting resources—also for small scale production. The semi-finished products are product-non-specific and can thus be used for a very broad spectrum of applications.

The good adaptability of the installation technology to different geometries also opens up opportunities for economic production of variant-rich series in mechanical engineering and in orthopedic technology. The fiber composite components are constructed from simple and specific semi-finished products and have a low waste. They are end contour precise, can be thermally joined to injection molded parts and do not require any corrosion protection.

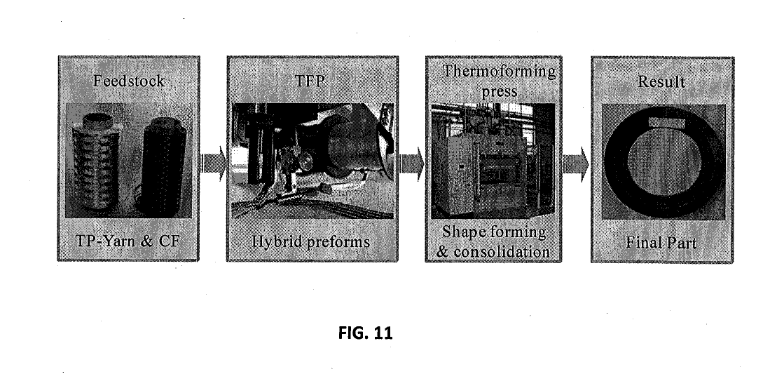

An overview of another example of a process chain is given in FIG. 11 for a frame structure. Feedstock, either a plied side-by-side (FIG. 11) or a commingled yarn is a combination of carbon fiber with thermoplastic multifilaments. For the side-by-side version the matrix filaments (PA6—Ultramid B27 03, BASF; PPS—Fortron 0320CO SF3001, Ticona; PEEK—Vestakeep 2000, Evonik) are produced on a melt spinning plant for technical multifilaments (F. Fourné) with a low degree of shrinkage and without sizing for a better fiber matrix adhesion. The corresponding carbon fibers were Tenax®-E HTS40 X011 12K 800 tex.

Preforms are produced on a TFP facility (Tajima TMLH-G108 Type D3-1) with a modified stitching head on a PVAL foil (Solublon, Typ KA 30 micron) as substrate.

Fiber lay-up with TFP-technology allows manufacturing of textile preforms with several layers in one step. Each hybrid yarn (plied or commingled) is fixed with an upper and a lower thread by zigzag stitches. Except for the substrate, a one layer preform is nearly symmetrical. Additional TFP-layers demand further upper and lower stitching thread, so that TFP-preforms have on the lower side a concentration of stitching thread. Furthermore, the lower layers are much more transfixed than the upper ones. To avoid matrix agglomerations (build-up of lower stitching thread) and filament damage the matrix will be modified with ferromagnetic particles (MagSilica® Evonik), in which a single particle has a nano scale. First estimations suggest that a nanoparticle concentration less than 1 weight percent, corresponding to the total CFRTP-part weight, will be enough to reach an economical preform production process.

The subsequent drapery and consolidation takes place in a Rucks KV 214 press. Here the melted stitching thread and the thermoplastic multifilament results in the matrix fraction. Basic parameters for the consolidation process are given by Schappe Techniques (“N.N.: ENSEMBLE Fiches BDEF GB Issue 03-2009, Schappe Techniques, 2009”) for a commercial commingled yarn (Nm 3.2 TPFL CARBON/PPS, Schappe Techniques). Moulding and demoulding temperature was 200° C. and consolidation temperature was 315° C. The realized heat-up and cooling-down speed was limited by the equipment to 10 K/min. Before testing a past-conditioning was made at 230° C.

Closing the material performance was characterized by polished cut image analysis and mechanical testing according to DIN EN 2561 (test apparatus Zwick/Roell Z250).

### Hybrid-Preforming

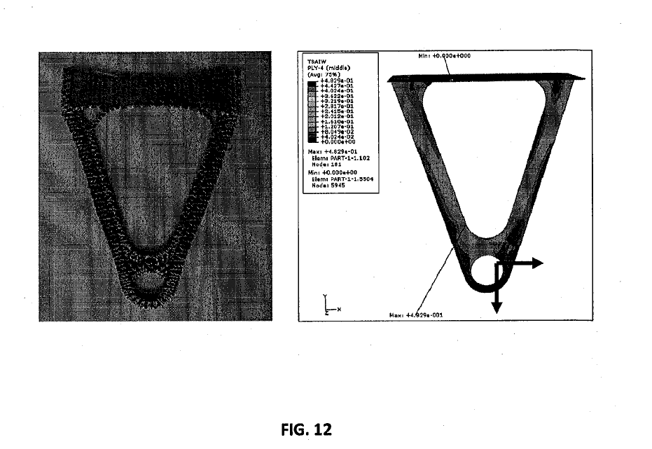

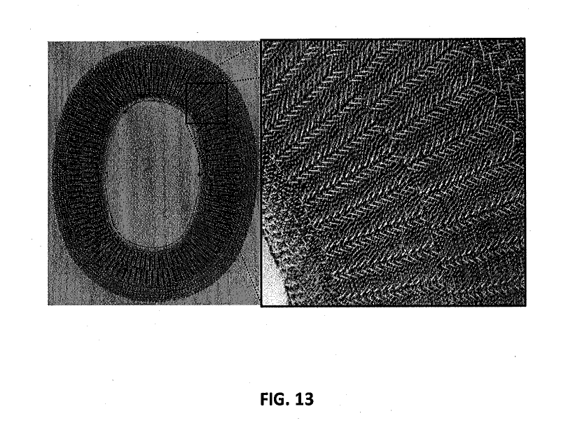

Different geometries of hybrid preforms have been realized. The geometrical flexibility of the TFP-Process is demonstrated in the shape of a hatrack bracket (FIG. 12; Hybrid TFP-Preforms for a hat track bracket with the side-by-side principle (left) and FEA of CFRP-Part with Tsai-Wu failure criteria (right) (“Shi, Y.: Beitrag zur Prozesskettenentwicklung von endlosfaserverstärkten Thermoplastbauteilen für Groβserien, Diploma Thesis, Universitat Bremen, 22.07.2009 Bremen”)) with the side-by-side principle and a window frame (FIG. 13; Hybrid TFP-Preforms for thermoplastic window frame made from commingled yarns (left) with detail (right)) for aircraft applications with commingled yarns. In general, this process is preferred for reinforcing load application regions and highly stressed structures.

Standard textiles like woven or knitted fabrics would have for this geometry more than 50% cutting scrap and a much lower performance from the mechanical point of view. The use of dry carbon fiber multifilament yarns enabled us fiber lay-up on small radii down to 10 mm without any visible filament undulations causes by the fiber path.

Because of the complex stress fields of load application areas, a combination of the consolidated CFRTP-part with injection die molding is useful for this part. Finite element analyses shows that this combination enhanced the ultimate load by about 30% while adding 15% weight of CFRTP (“Shi, Y.: Beitrag zur Prozesskettenentwicklung von endlosfaserverstärkten Thermoplastbauteilen für Groβserien, Diploma Thesis, Universitat Bremen, 22.07.2009 Bremen”).

The preform in the photo in FIG. 13 consists of 3 layers with different ply arrangement geared to a polar coordinate system. Both principles of hybrid TFP-preforms are characterized by a good repeatability due to the high degree of automation.

### Consolidation

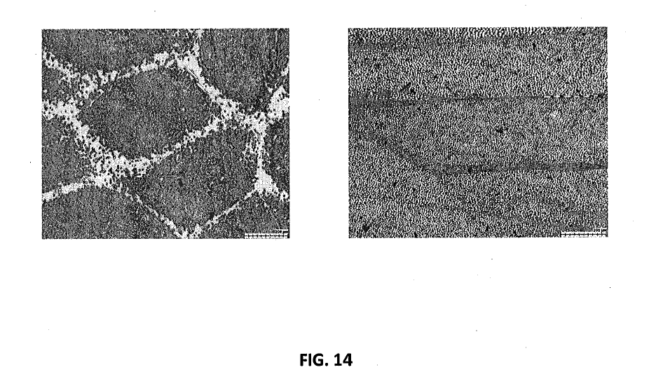

The internal laminate-structure of hybrid preforms made from commingled yarns as well as the ones which were created in side-by-side technology is regular. Polished cut images of laminates made from commingled yarns from Schappe Techniques are characterized by resin rich areas (FIG. 14; Polished cut image of unidirectional laminates made of Nm 3.2 TPFL CARBON/PPS, Schappe Techniques commingling yarn (left)). The reinforcement fibers appear in fiber bundles. Polished cut image of laminates made from hybrid side-by-side preforms show a more homogeneous fiber allocation (FIG. 14; TICONA® PPS-Fortron 0320CO SF3001/Tenax®-E HTS40 X011 12K 800 tex side-by-side (right)).

In both cases the laminates are fully impregnated and no phase separation is visible. The stitching thread is completely melted and has become a part of the matrix. The realized fiber volume content is about 45%.

### Mechanical Properties

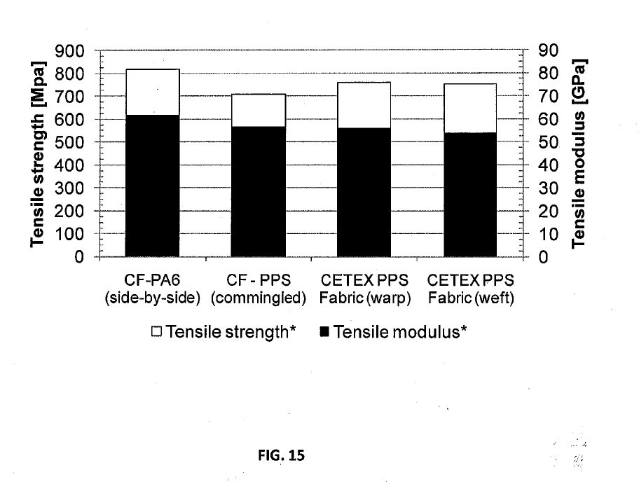

FIG. 15 (Comparison of tensile properties of laminates made from hybrid perform and commercial CFRTP-Laminates made from woven fabrics (*all values are related to a total fiber volume content of 50%)) is showing the determined tensile properties of produced PA6 laminates made from side-by-side hybrid preforms and PPS laminates made from commingled yarns compared with properties of commercial CFRTP-laminates (“N.N.: Mechanical Data for Carbon CD0286/PPS, TenCate, 2006”) for the aircraft industry. For easy comparison with the commercial woven 0°/90°-laminates (fiber volume content of 50%) the values of the test laminates are scaled up to the identical fiber volume content.

Actually, the realized mechanical properties are higher for the side-by-side laminate than for the commercial ones due to the more stretched fibers without woven undulations. For the commingled yarn especially the tensile modulus is lower due to fiber breakages caused by the commingling process.

Depending on later applications the used hybrid yarn can consist of different types of reinforcing fibers (carbon, glass, basalt, aramid) and any type of thermoplastic resin. Preferable are high performance thermoplastic resins like Vestskeep 2000 G (PEEK, Evonik). The hybrid yarn build-up can be side-by-side, commingled or wrapped, in which the reinforcing fiber volume content can be designed regarding the later application (e.g. aircraft industry 50%).

For the preliminary induction analyses modified matrix filaments are produced with a spinning tester in vertical direction (SDL Atlas—Laboratory Mixing Extruder). The corresponding PEEK compounds were delivered by Evonik with a MagSilica® 50-85 (content of 10 weight-%) and MagSilica® VP300 (content of 15, 20 and 30 weight-%). MagSilica VP300 is particularly advantageous for heating. The spun filaments are characterized by polished cut image analysis, scanning electron microscopy (SEM) and mechanical single fiber testing according to DIN EN ISO 5079: 1996 (Dia-Ston equipment). Afterwards the heat up behavior is analyzed using a Himmelwerk Sinus 52 ring coil (inner diameter: 6 mm, length: 22 mm, power: 6.0 kW; frequency: 1.8 MHz) and contactless temperature measurement.

### Filament Spinning

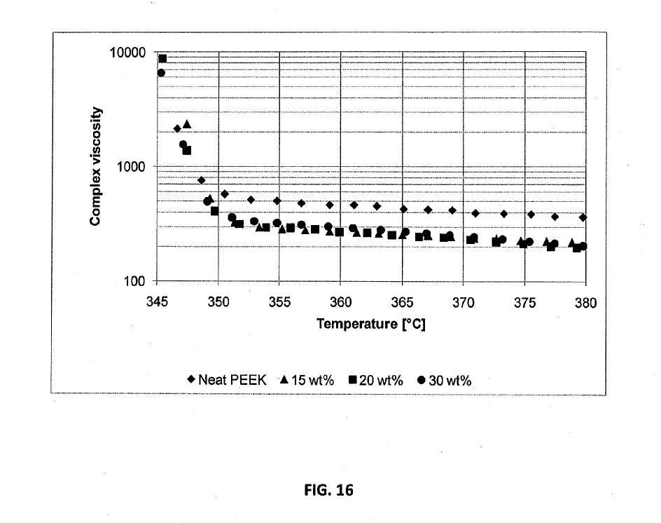

The effect of Vestakeep 2000 G modification through MagSilica® 300VP is shown in FIG. 16 (Influence of MagSilica® VP300 on Vestakeep 2000 G). As can be seen from the graph the complex viscosity decreases when MagSilica® is added to the polymer. Overall the viscosity is in the preferable region (100-1000 Pa·s) for the melt spinning process. In this viscosity region, the fiber formation shows normally the best performance and the process stability is increased.

The filament spinning takes place at 360° C. In contrast to pure PEEK the spinning temperature has to be lowered for a good fiber formation due to the lower viscosity. The lower spinning temperature results in higher melt stiffness but otherwise the nanoparticles induce melt fracture. However, spin drafts up to 100 could be reached in the laboratory scale. In comparison to typical spin drafts for melt spun fibers (F. Fourné, “Synthetische Fasern—Herstellung, Maschinen und Apparate, Eigenschaften”; Handbuch für Anlagenplanung, Maschinenkonstruktion und Betrieb; Hanser Verlag, München/Wien, 1995, Chapt. 3, p. 182″) this is promising regarding the industrial implementation.

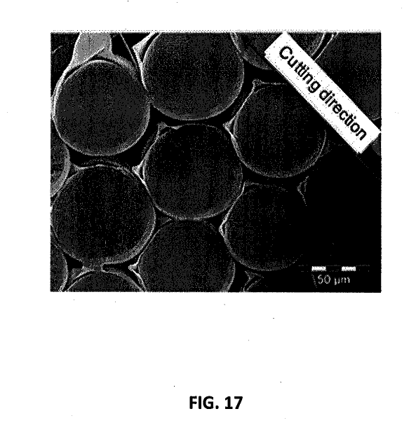

If the higher spinning speeds in industrial scale cause unexpected filament breakages the core/shell filament build up could be used, whereas a non-modified pure PEEK core acts as a spinning carrier (FIG. 17; Core/shell filaments). With this type of filament, a non-fiber forming thermoplastic resin can also be used as shell component.

The core/shell structure generates also more advantages for which reason this filament structure is preferred.

1. During the bonding the unmodified core stabilized the melted shell, whereby faster perform production rates can be used.

2. To reach high heating rates the MagSilica® content of the shell can be chosen very high, whereas the unmodified core makes sure that the overall concentration is still low. The feasibility through the spinning carrier effect is ensured.

3. Through changing the thickness the adhesion strength can be controlled. Normal industrial shell fraction can be from 1-99 vol.-%.

4. Depending on the application different materials can be used for the core and shell component. It is not necessary that core and shell have the same polymeric feedstock.

5. Overall this technology can generate CFRP-parts with a very low amount of nanoparticles:

30 wt-% MagSilica® in the shell corresponds to 11 vol-%. With 10% shell fraction and 50% modified binding matrix filaments this leads to 0.3 vol-% nanoparticles for an aircraft component with a fiber volume content of 50%.

1. During the bonding the unmodified core stabilized the melted shell, whereby faster perform production rates can be used.

2. To reach high heating rates the MagSilica® content of the shell can be chosen very high, whereas the unmodified core makes sure that the overall concentration is still low. The feasibility through the spinning carrier effect is ensured.

3. Through changing the thickness the adhesion strength can be controlled. Normal industrial shell fraction can be from 1-99 vol.-%.

4. Depending on the application different materials can be used for the core and shell component. It is not necessary that core and shell have the same polymeric feedstock.

5. Overall this technology can generate CFRP-parts with a very low amount of nanoparticles:

30 wt-% MagSilica® in the shell corresponds to 11 vol-%. With 10% shell fraction and 50% modified binding matrix filaments this leads to 0.3 vol-% nanoparticles for an aircraft component with a fiber volume content of 50%.

### Filament Properties

With 90-100 MPa for the tensile strength, complete nano-modified PEEK filaments are comparable to neat PEEK according to DIN EN ISO 527-2. These mechanical properties (for unstretched filaments) are sufficient for a safe handling during the modified TFP process. Depending on the process parameters filament diameters can be realized between 10 and 100 μm.

For stretched filaments the tensile strength is preferably in the range of about 300 to about 1000 MPa.

### Heat Up Behavior

Heating up experiments showed that with MagSilica® VP300 higher heating rates can be generated in comparison to MagSilica® 50-85. Therefore, the following results concentrate on VP300.

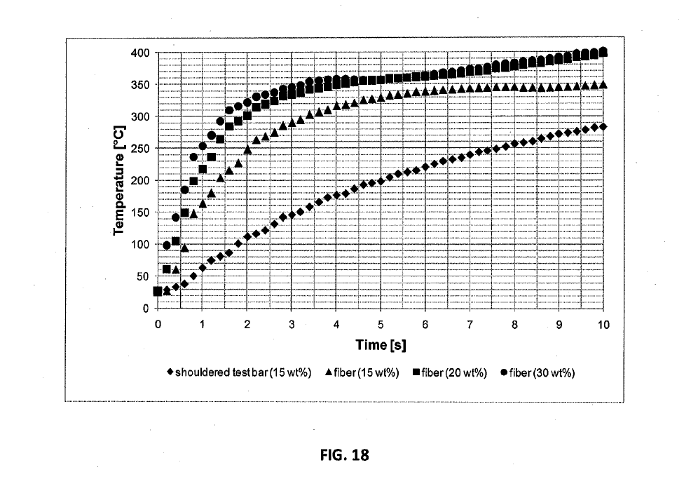

A big advantage of using filament is the possibility of using high performance induction coils. These coils are very compact with inner diameters less than 10 mm. The influence of the used equipment can be seen in FIG. 18 (Heat up behavior of different test specimen). The reached heating rate of a shouldered test bar (normal induction coil, frequency: 675 kHz) is only half as fast as the equivalent fiber in the interesting timeframe of the first 3 seconds.

Furthermore, filaments, modified with 30 wt.-% MagSilica VP300, reach the melting region of PEEK within 0.7 seconds (about 510 K/s). Latest induction tests with MagSilica HS even shown that heating rates of 720 K/s to reach PEEK melting temperature are possible, whereby the use of these technologies for nearly all thermoplastic resins is verified.

It will be appreciated that an appropriate process chain is not limited to the two examples described herein. For example, the number and kind of steps as well as the parameters of the steps could be modified.

The process chains set out and the possible products have at least in particular embodiments the following advantages individually or in combination:

The new fixing type of the hybrid yarn facilitates, in comparison with TFP technology, the damage-free lay-up of reinforcement fibers also on paths with low radii of curvature (lay-up radii) and for thick preforms.

In comparison with existing tow placement systems, clearly smaller in-plane lay-up radii without fiber waviness can be realized.

Apart from the very small proportion of ferromagnetic and/or ferrimagnetic particles, no further auxiliary agents such as low melting thermoplastic binding agents are required, which can lead according to the field of use of the material to reducing hot-wet properties.

Material properties can be optimally adapted to the component loads via the tailor-made orientation of the reinforcement fibers.

Through the high degree of automation of the process chain, a customer-orientated production in countries with a comparatively high wage level is possible. Process security is guaranteed.

With the production of the preforms on end contour by means of the tow placement method the cutting of the flat textile product is avoided. Besides costs for the cutting devices and staff, the otherwise usual waste is clearly reduced. Quality losses which are otherwise caused in the form of fiber undulations in the cutting process and the handling of flexible textiles do not have to be considered either.

The sufficiently high rigidity of the fiber preform facilitates storage and safe transportation. The production of the preforms can take place in the textile supplier industry. The workload of component-unspecific tow placement systems is thus ensured and the respective expert knowledge of the different branches of the economy is used.

The short cycle times allow the realization of lightweight construction concepts for a broad field of application. The new products are thereby characterized by low weight, increased performance capacity and reduced energy consumption in operation.

The new fixing type of the hybrid yarn facilitates, in comparison with TFP technology, the damage-free lay-up of reinforcement fibers also on paths with low radii of curvature (lay-up radii) and for thick preforms.

In comparison with existing tow placement systems, clearly smaller in-plane lay-up radii without fiber waviness can be realized.

Apart from the very small proportion of ferromagnetic and/or ferrimagnetic particles, no further auxiliary agents such as low melting thermoplastic binding agents are required, which can lead according to the field of use of the material to reducing hot-wet properties.

Material properties can be optimally adapted to the component loads via the tailor-made orientation of the reinforcement fibers.

Through the high degree of automation of the process chain, a customer-orientated production in countries with a comparatively high wage level is possible. Process security is guaranteed.

With the production of the preforms on end contour by means of the tow placement method the cutting of the flat textile product is avoided. Besides costs for the cutting devices and staff, the otherwise usual waste is clearly reduced. Quality losses which are otherwise caused in the form of fiber undulations in the cutting process and the handling of flexible textiles do not have to be considered either.

The sufficiently high rigidity of the fiber preform facilitates storage and safe transportation. The production of the preforms can take place in the textile supplier industry. The workload of component-unspecific tow placement systems is thus ensured and the respective expert knowledge of the different branches of the economy is used.

The short cycle times allow the realization of lightweight construction concepts for a broad field of application. The new products are thereby characterized by low weight, increased performance capacity and reduced energy consumption in operation.

The features of the invention disclosed in the present description, in the drawings, and in the claims, can be essential to implementing the invention in its various embodiments both individually and in any combinations. It is contemplated that several modifications can be made to the embodiments described herein within the spirit and scope of the invention without departing from the anticipated scope of the claims.

What is claimed is:

1. A method for producing a fiber preform or semi-finished textile product comprising:
providing a fiber preform or semi-finished textile product comprising at least one thermoplastic fiber, the thermoplastic fiber having a core constructed of a first material, a shell constructed of a second material positioned to surround the core, and magnetic particles that are one of mainly arranged in the shell, almost exclusively arranged in the shell, and exclusively arranged in the shell;
continually adding the fiber preform or semi-finished textile product with simultaneous heating thereof in continuous passing through or passing by a magnetic induction heating device or the same by way of a relative movement; and
fixing the fiber preform or semi-finished textile product by allowing the fiber preform or semi-finished textile product to rigidify.

2. The method of claim 1 wherein the fiber preform or semi-finished textile product comprises a plurality of reinforcement fibers.

3. The method of claim 1 wherein the first material and the second material are identical.

4. The method of claim 1 wherein the first material and the second material are different.

5. The method of claim 1 wherein the fiber is unstretched.

6. The method of claim 1 wherein the fiber is stretched.

7. The method of claim 1 wherein the core has a diameter in the range of about 5 μm to about 60 μm.

8. The method of claim 1 wherein the core has a diameter in the range of 20 μm to 30 μm.

9. The method of claim 1 wherein the heat-up performance of the fiber preform or semi-finished textile product is controlled by way of a concentration of the magnetic particles, the thickness of the shell, or both.

10. The method of claim 1 wherein the shell has a thickness in a range of about 0.1 μm to about 20 μm.

11. The method of claim 1 wherein a concentration of the magnetic particles in the shell is in a range of about 10 weight percent to about 50 weight percent.

12. The method of claim 1 wherein the fiber preform or semi-finished textile product is suited for the thermal fixing of fiber preforms

13. The method of claim 1 wherein the fiber preform or semi-finished textile product is suited for the thermal fixing of fiber preforms for, endless fiber reinforced, fiber composite components, and in particular high performance fiber composite components.

14. The method of claim 1 wherein the thermoplastic fibers include at least one of polyetherketone, polyetheretherketone (PEEK), polyphenylene sulphide (PPS), polyimide, particular polyetherimide (PEI), polysulfone (PSU), polyethersulfone (PES), polyamide (PA) and polyvinylidine fluoride (PVDF).

15. The method of claim 1 wherein the carrying layer is two-dimensional.

16. The method of claim 1 wherein the fiber preforms are for endless fiber reinforced, fiber composite components.

17. The method of claim 1 wherein the fiber preforms are for high performance fiber composite components.

18. The method of claim 1 further comprising, after heating and before fixing the fiber preform or semi-finished textile product, lay-up of the fiber preform or semi-finished textile product in any path curve on a carrying layer.

19. The method of claim 1 further comprising, after heating and before fixing the fiber preform or semi-finished textile product, lay-up of the fiber preform or semi-finished textile product in any path curve on a carrying layer, wherein the fiber preform or semi-finished textile product is pressed during or after lay-up on the carrying layer.

20. The method claim 1 in which the magnetic particles comprise ferromagnetic particles, ferrimagnetic particles, or both.

21. A method for producing fiber composite components comprising:
providing the continuous addition of the fiber preform or semi-finished textile product having a plurality of reinforcement fibers, a plurality of thermoplastic fibers, and at least some of the plurality of thermoplastic fibers including at least one of proportionately ferromagnetic particles and proportionately ferrimagnetic particles;
simultaneous heating thereof in continuous passing through or passing by a magnetic induction heating device or the same;
fixing of the fiber preform or semi-finished textile product by allowing it to rigidify; and
thermoforming of the fiber preform produced for the production of a three-dimensionally formed fiber composite component.

22. The method of claim 21 wherein the components are endless fiber reinforced, fiber composite components.

23. The method of claim 21 wherein the components are high performance composite components.

24. The method of claim 21 wherein the carrying layer is two-dimensional.

25. The method of claim 21 further comprising, after heating and before fixing the fiber preform or semi-finished textile product, lay-up of the fiber preform or semi-finished textile product in any path curve on a carrying layer.

26. The method of claim 21 further comprising, after heating and before fixing the fiber preform or semi-finished textile product, lay-up of the fiber preform or semi-finished textile product in any path curve on a carrying layer, wherein the fiber preform or semi-finished textile product is pressed during or after lay-up on the carrying layer.
